(19) United States
(12) Patent Application Publication
(10) Pub. No.: US 2009/0295118 A1
(43) Pub. Date: Dec. 3, 2009

(54) Lever enhanced pedaling system's hydraulic assisted propulsion mechanism

(76) Inventor: Rashad Na'im Scarborough, Durham, NC (US)

Correspondence Address: Rashad Na'im Scarborough, 411 E. Pilot St Apt A8, Durham, NC, 27707, US

(21) Appl. No.: 12/291,353

(22) Filed: Nov. 10, 2008

Related U.S. Application Data
(60) Provisional application No. 61/002,667, filed on Nov. 9, 2007.

(51) Int. Cl. B62M 1/04

(52) U.S. Cl. 280/216

(57) ABSTRACT

A propulsion mechanism for propelling a bicycle forward, which is composed of two complex lever machines designed to amplify energy, wherein each machine has the ability to be moved in a reciprocal motion, wherein each machine has an approximate “L” shape, wherein the shorter side is in the approximate vertical position and the longer side is in the approximate horizontal position, wherein the transmission chain is pulled from a vertical point on the lever machine in a pivotal motion, while a separate, but connected hydraulic machine pulls the same transmission chain in a linear motion due to the downward pedaling pressure pulling the master piston, which pushes out hydraulic fluid from the piston chamber against a larger slave piston in its own separate chamber, which causes hydraulic force to be multiplied, which would result in multiplied traveling range per pedal with a sufficient amount of torque.

Continuation-in-part of application No. 61/002,667, filed on Nov. 11, 2007.

### BACKGROUND OF THE INVENTION

1. Field of Invention

This invention relates to fluid mechanisms integrated into human powered bikes, designed to enhance their propulsion performance.

2. Background of the Invention

In the bicycle industry a significant number of inventors have designed bicycles that incorporate systems such as hydraulic or pneumatic powered machines that were intended to make pedaling transportation easy for mankind.

Although these mechanisms offer a wide variety of propulsion benefits, they lack advantages that the Lever Enhanced Pedaling System (LEPS) offer, which includes certain properties of a lever machine assisted by hydraulic power. Similar systems can be found in hydraulic jacks used to lift trucks and cars for repair. The hydraulic pump is usually located between the area of applied force and load to be lifted. However, this mechanism would be unique when applied to a bicycle format.

Inventors in this field have invented a myriad of piston driven machines incorporated into bicycles that utilizes the mechanical advantage of compressing air or liquid in order to force one or more radial members connected to its member rear wheel to be propelled forward. These ideas, although possibly efficiently, are different compared to the Lever Enhanced Pedaling System's (LEPS) Hydraulic Assisted Propulsion Mechanism.

Some examples of distinguished prior art are the Hydraulic Drive For a Bicycle (U.S. Pat. No. 3,729,213), the Bicycle (U.S. Pat. No. 576,538), the Air Engine (U.S. Pat. No. 614,992), the Motor Bicycle (U.S. Pat. No. 735,628) and Improvements in and Relating to Drive Mechanisms (0063895).

The Hydraulic Drive For a Bicycle (U.S. Pat. No. 3,729,213) uses two hydraulic cylinders to pump hydraulic fluid through their member hydraulic line to rotate a motor coupled to the bike's frame which further revolves a linked chain which is wrapped around a larger sprocket and turns the rear wheel as its as its smaller sprocket member is turned. The LEPS uses a master cylinder and piston which pushes hydraulic fluid through a line then pushes fluid up through the bottom of the slave cylinder where hydraulic force is multiplied. The slave piston pulls a transmission chain while being rotated rearwards on the lever machine it is mounted to. This piston pulling of the chain, while the entire hydraulic machine is being pivoted creates a mechanism in which two force multiplying machines are pulling the transmission chain simultaneously. This should generate more range per pedal with an above average amount of torque from both machines. What distinguishes the LEPS's hydraulic mechanism from the Hydraulic Drive For a Bicycle is that the LEPS does not utilize a hydraulic motor, but rather a slave cylinder and piston in which its purpose is to multiply hydraulic force due to hydraulic fluid pushing against a larger piston surface area as compared to its master counterpart.

The Bicycle (U.S. Pat. No. 576,538) invented by C. H. Bellamy incorporates a right and left side pneumatic cylinder and piston which pumps air from its master cylinder, while its piston is being pulled by its lever member from between the fulcrum and area of applied force to three separate slave cylinders that operate internally within a hollow circular casing The casing has fastened to its inner circumference internal spur gear teeth, which allows its three spur gears to turn said casing due to separate crank arms being pushed and pulled by member slave pistons. The spokes of the rear wheel are connected to the hollow casing which allows the rear wheel to turn along with the casing.

The LEPS's hydraulic assisted mechanism is distinguished from the latter bicycle, because it integrates its slave cylinders into its lever machine and its slave cylinder is not stationary because it moves with its member lever machine below the fulcrum. Furthermore, levers used by the LEPS are not curved, but “L” shaped and should have more mechanical leverage because it spreads work effort throughout a longer lever length and has its transmission means pulled closely from its member fulcrum.

The Air Engine (U.S. Pat. No. 614,992) from M. Schmidt utilizes a pneumatic master cylinder and piston which pumps air into its pneumatic frame reservoir, which holds air until the air is sufficiently compressed for reciprocating the piston of the engine or slave piston which forces the crank arm in rotation. The LEPS is different with regard to this machine because it is hydraulic, not pneumatic. Furthermore the LEPS's frame does not hold compressed air or liquid, but it has fluid contained in its hydraulic lines as well as the master and slave cylinders.

The Propelling Mechanism for Bicycle or Similar Vehicles (U.S. Pat. No. 610,956) uses a cylinder and piston which forces air through its piston chamber into a motor which turns the rear wheel connected to it. Again the LEPS is distinguished from this hydraulic powered motor, in that it uses a slave piston within its hydraulic cylinder that pulls the transmission means engaged to the rear wheel sprocket, which rotates said sprocket and turns the rear wheel connect to it. The LEPS does not use a motor rotated by pneumatic force, nor does it have a reservoir within the frame storing air. The LEPS's force multiplying machines are simple, which are meant to multiplying torque and traveling range at the same time.

The Motor Bicycle (U.S. Pat. No. 735,628) has similar properties to the first described prior art. This system uses a second class lever and crank arm to push its piston back and forth within its cylinders. The propulsion means is composed of duplicate master cylinders which push air into a radial member, which receives alternate forces of air from each cylinder jetted into its curved triangular chambers forming the outer surface of the radial member. Each piston is pushed and pulled by each crank arm, while the bicycle is being pedaled. The arms attached to each crank arm, the right being 180 degrees and the left being 90 degrees forces their attached arms to push and pull its member pneumatic piston. Then the air is heated before it enters the radial array of triangular chambers which jets air into each the chamber to rotate it, which further turns the attached rear wheel forward.

The LEPS's hydraulic assisted propulsion mechanism does not utilize a radial chamber that receives air or liquid. Again the force is multiplied by a lever machine having a long lever to divide pedaling effort throughout its length while integrating a slave cylinder having a piston that receives hydraulic pressure from the master piston chamber which has a piston with a smaller surface area than its slave piston counterpart. Furthermore, the master cylinder pivots on the frame of the bicycle and is not stationary like the latter described invention.

The Improvements in and Relating to Drive Mechanisms (0063895) utilizes pistons which pulls hydraulic fluid through its cylinders having the ability to pivot from the frame of the bicycle (FIG. 3). Hydraulic fluid is then fed to the hydraulic motor which turns the rear wheel as the rider applies downward pressure to the piston rod connected to the lever machine from which downward pedaling force is applied to. The LEPS uses a similar hydraulic piston which swings from the frame, but a steel cable runs through each piston rod, which allows each piston to reciprocate while the said cable is sustained by pulley wheels mounted to the frame. The LEPS uses duplicate slave pistons within its two hydraulic cylinders where hydraulic force is multiplied. The hydraulic lines of the hydraulic machine can be clearly visible which emphasizes the seriousness of the machine, because it illustrates how the machine functions as opposed to concepts that don't illustrate how their mechanism actually work.

### SUMMARY

The corresponding description of the LEPS's hydraulic mechanism in conclusion are two lever propulsion machines coupled to the bicycles frame that integrates a hydraulic system into each lever configuration which allows hydraulic force to be an extension of lever mechanical force for the purpose of achieving maximum range and torque.

### FIGURES

FIG. 1 illustrates the right side view of the LEPS'S hydraulic system.

FIG. 2 illustrates the broke away section of the LEPS'S hydraulic system and how it pulls the transmission chain 20 upwards.

FIG. 3 illustrates the second broke away section exposing the slave piston's 18 placement in its member cylinder 16 and how the hydraulic line 12 is connected to the machine 66.

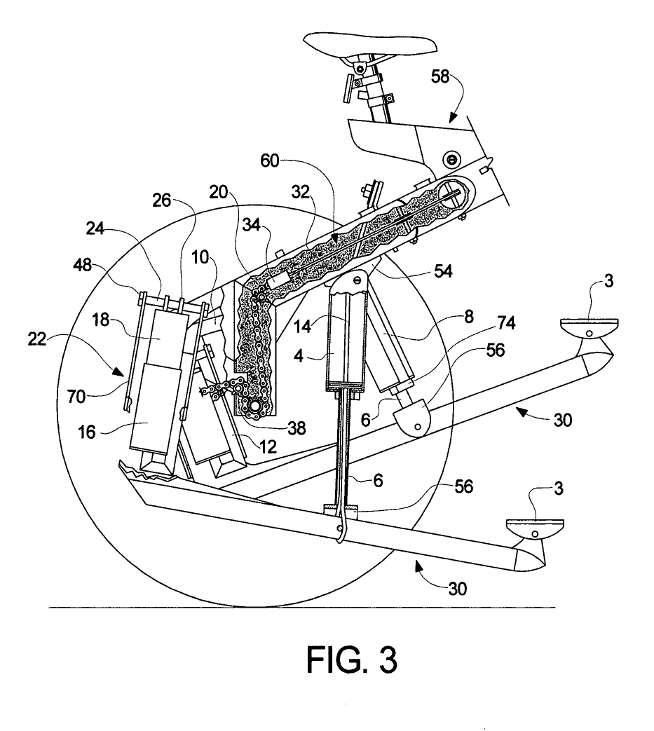

FIG. 4 illustrates the traveling direction of the hydraulic fluid 9 and the hydraulic lines of the master and slave hydraulic machines.

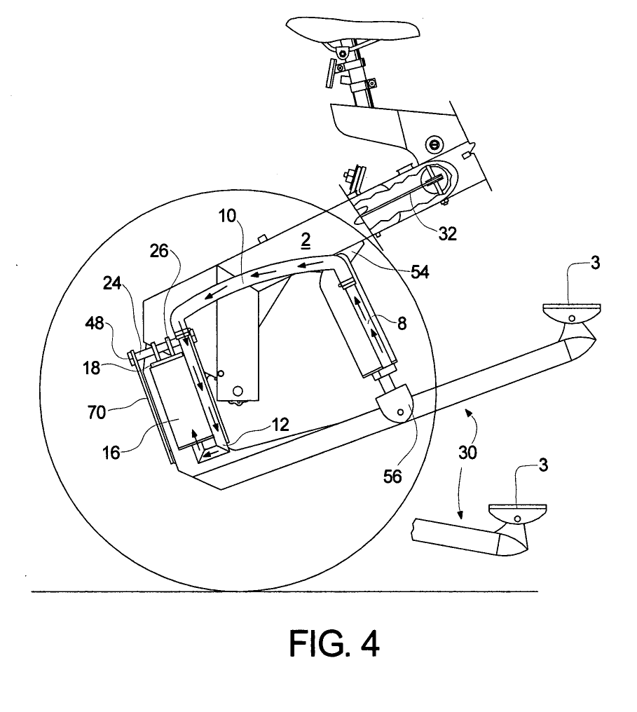

FIG. 5 illustrates a detailed view of how the master piston 5 pulls hydraulic fluid 9 in its chamber 4, the inner workings of the reciprocal systems and how hydraulic fluid 9 pushes the slave piston 18 upwards.

FIG. 5A illustrates a detailed view of how the master piston 5 pulls hydraulic fluid 9 through its rectangular aluminum piece 74 up through its connected hydraulic line 8.

FIG. 6 illustrates how the transmission means 60 reciprocates within the frame 2 of the LEPS.

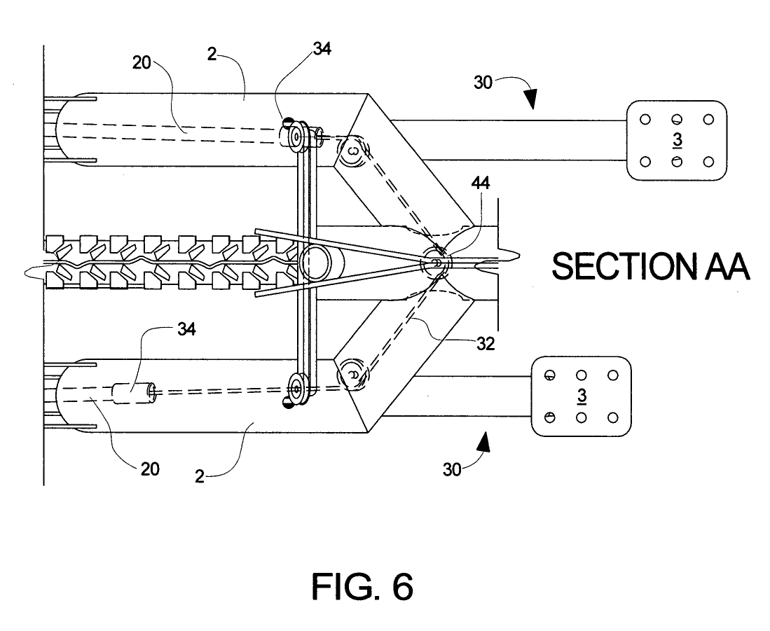

FIG. 7 illustrates how each “L” shaped plate 70, that is connected to its piston 18, pulls its member transmission chain 20 within the vertical walls of each lever machine 30.

### REFERENCE NUMERALS

1 rubber seal
2 frame
3 pedals
4 master cylinder
5 master piston
6 piston rod
7 rubber seal
8 master hydraulic line
9 hydraulic fluid
10 hydraulic tube
12 slave hydraulic line
14 reciprocal cable
16 slave cylinder
17 rubber seal
18 slave piston
20 transmission chain
22 chain anchor
24 lifter shaft
26 shaft mount
28 wheel bearings
30 lever tubes
31 vertical plates
32 transmission cable
34 chain connector
36 hydraulic sprocket
38 router sprocket
40 load sprocket
42 reciprocal sprocket
44 reciprocal pulley wheel
46 fulcrum
48 nuts
50 chain cylinder
52 suspension shaft
54 suspension plates
56 tube holder
58 seat post wings
60 transmission means
62 radial members
64 rear wheel hub
66 hydraulic machine
68 polygon plates
70 “L” shaped plates
72 hydraulic machine mounts
74 aluminum block
76 tube holder bolt
78 reciprocal pulley wheels

### DETAILED DESCRIPTION OF THE INVENTION

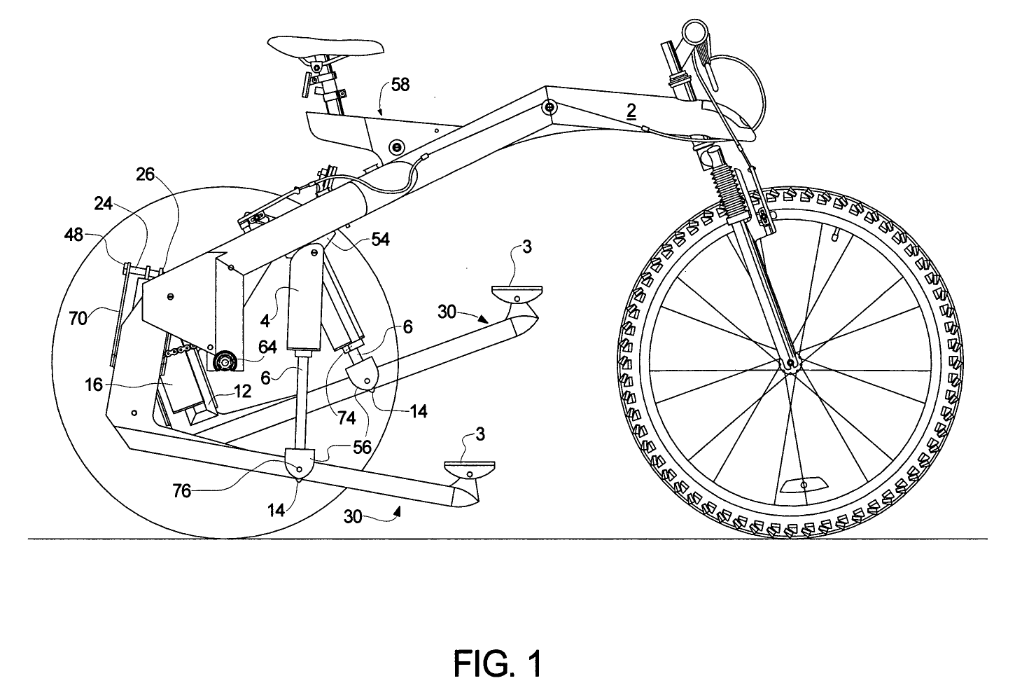

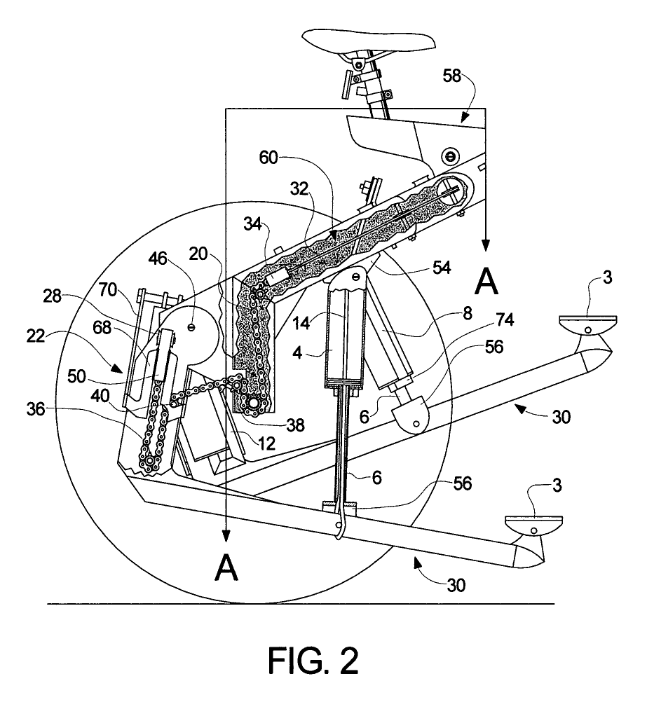

Below is a description of components, assemblies, materials and the mechanical configurations according to drawings illustrated in FIG. 1. The Lever Enhanced Pedaling System's (LEPS) hydraulic assisted propulsion system is composed of a tubular frame 2 which accommodates a linear chain transmission means 60 linking mechanical force from the vertical portion of each lever machine 30 to separate connected radial members on opposite sides of the rear wheel's hub. The transmission means (FIG. 2) 60 is composed of two chains 20 having an end that is bonded to opposite ends of a steel cable 32. Each bond is constructed out of a steel cylinder 34 which encompasses the portion where each chain 20 end meets opposite ends of the steel cable 32, which is positioned between the chains 20 lengthwise. Within each steel cylinder 34 is a J.B. weld resin, which is poured into each cylinder 34 and hardened while the end of each cylinder's 34 member chain 20 is within its walls as well as one end of the steel cable 32. This steel cable 32 is positioned within the central tube of the frame 2 around the leading groove of the pulley wheel 44 under the wing like seat post cylinder foundation 58. The pulley wheel 44 is mounted within the central tube of the frame 2 by a threaded rod having its two ends accommodating separate bores on opposite sides of the central tube 2 through the top and bottom surfaces. The threaded rod is fastened in place by at least one lock nut washer between two nuts above and below the central tube of the frame 2. The pulley wheel 44 is further secured in place by at least one lock nut washer fastened between two nuts above and below the pulley wheel 44. The pulley wheel's 44 flat surface is aligned to the length of the central tube of the frame 2 which allows the mid portion of the transmission assembly 60 to be parallel to the length of the central tube 2. The chain portion 20 of the transmission means is 58 then routed over and rearward around the reciprocal sprocket 42. Then downwards in front of and under the radial member 62 of the rear wheel hub 64. The chain 20 is then routed upward, over and rearward to the load sprocket 40 of its member lever machine 30. The opposite portions of the linear transmission means 60 are integrated into two force multiplying machines. These include the lever machine 30 and the hydraulic machine 66. There are three classes of lever machines in which the load, fulcrum and area of applied force (pedals) are positioned in three different ways which determines their class. The LEPS uses the second class lever, in which the load being moved is positioned between the fulcrum and the area of applied force. Thus, the load is the points of contact where the transmission chain 20 meets the surface of the load sprocket 40 mounted between the vertical plates of the lever machine 30. The chain 20 is then routed over and around the load sprocket 60. Then downward in front of and under the hydraulic sprocket 36, then upward into a steel square tube 50, which is welded between two pairs of steel polygon plates 68. The lower portion of the tube 50 has three bores through opposite surfaces that are aligned to allow three machine screws to accommodate them as well as three opening in the links of the transmission chain 20. Each machine screw is to be fastened in place. The fourth pair of bores is through the upper portion of the steel tube 50, which are in alignment with an opening in the link of the transmission chain 20. The alignments accommodate a threaded shaft which occupies the bores of two pulley wheels 28. These pulley wheels 28 are to be fastened in place with a nut and lock nut washer. These pulley wheels 28 have the ability to roll on the inner surface of the vertical plates that are facing outwardly on each lever machine 30. Their purpose is to reduce the friction from the upper edge of the square tube portion of the chain anchor, as it pivots outwardly against the inner wall of the outer vertical plate due to it moving upwards with its coupled slave piston. The upper portion of the chain anchor 22 is pulled by the lifter shaft 24 mounted to said piston 18.

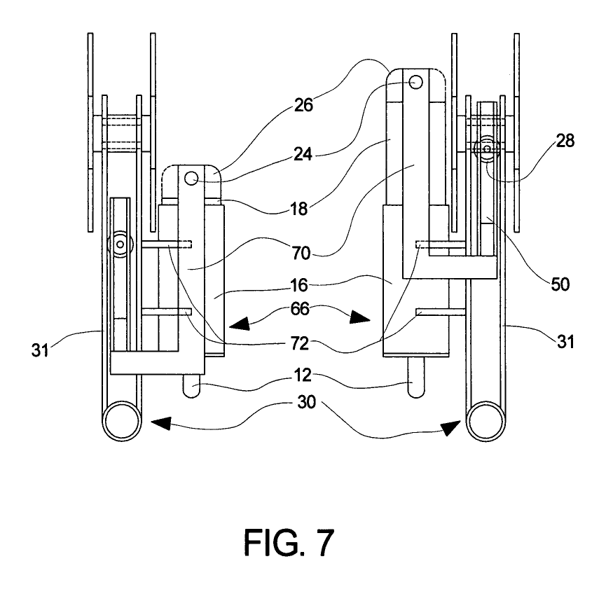

Welded to the opposite sides of the polygon plate 68 assembly are separate “L” shaped plates 70 in which the shorter end portion of both “L” shape plates 70 are pointing outwardly. Two aligned bores are through each upper vertical end portion of these “L” shape plates 70. These bores accommodate a shaft 24 which runs through two aluminum plates 24 that are upright, parallel and welded onto the top edge of the slave piston 18. The “L” shaped assembly 22 is able to pivot within the bores of the aluminum plates 26. The slave piston 18 occupies the slave cylinder 16. The slave cylinder 16 is welded to two plates with curved edges 72 (FIG. 7) having the same radius as the outer diameter of the slave cylinder 16 so that both inner edges and outer surface may establish contact perpendicularly and be welded in place. The other end of the curved edge plates are flat and are to be welded perpendicularly to the inward facing surface of the vertical plate of the lever machine 30. The curved edge plate's 72 purpose are the maintain a space between the slave piston 16 and rear frame plates that extends from the rear vertical tube of the frame 2 accommodating the rear wheel axle. These rear extensions are two triangular parallel plates that have an aligned bore which accommodates the fulcrum 46 of the lever machine 30. Between these plates are the two vertical plates 31 of the lever machine 30.

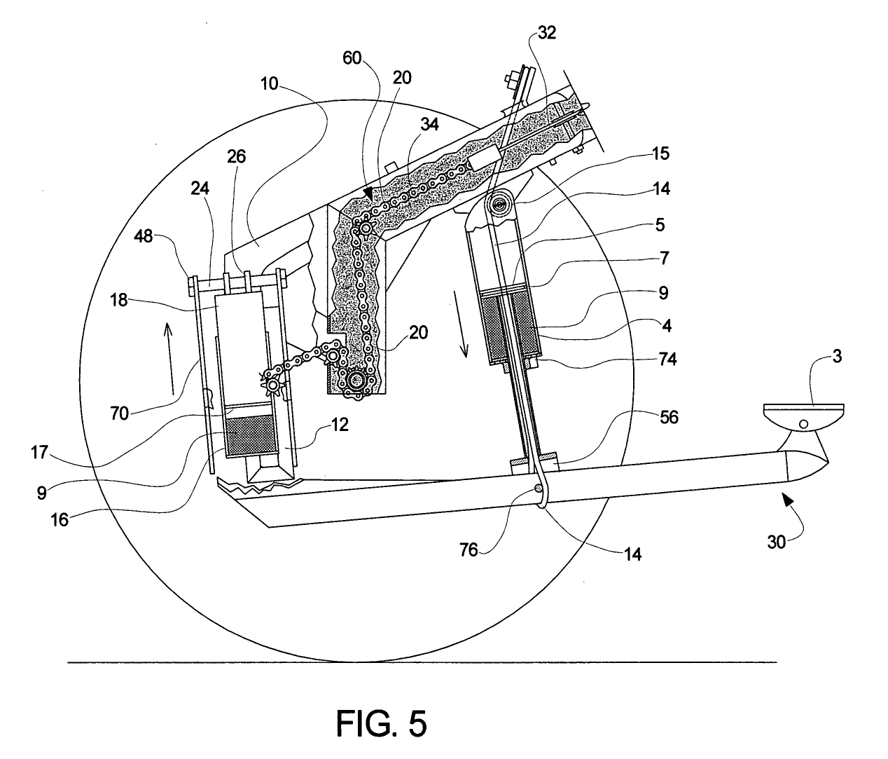

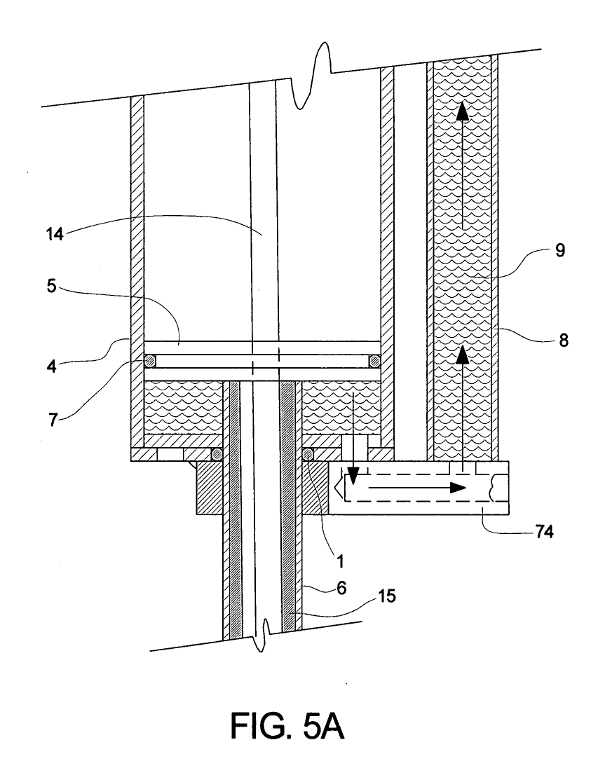

The slave piston 18 is made out of 6061 aluminum (FIG. 5). It would be trimmed on a lathe machine to attain an effective hydraulic fit. The slave piston 18 should be able to tightly fit in the slave cylinder 16 with a low tolerance of plus/minus 0.001″. Furthermore, a horizontal groove is cut into the pistons lower outer wall about ⅛″ wide× 1/16″ deep, which would accommodate a circular rubber seal 17 for the purpose of conforming to the inner walls of the slave cylinder 16 and filling micro gaps left by the aluminum piston 18. The assembly of rubber 17 and piston should allow hydraulic fluid to push the flat bottom surface of the slave piston 18 upwards within the walls of the slave cylinder 16 causing the upper edge of the slave piston 18 to rise away from the upper edge of the slave cylinder 16. The slave cylinder 16 has a 0.50″ bore through the center of its bottom surface, which is encompassed by an aluminum cylinder 12 with a 0.675 outer diameter and 0.50 inner diameter. Thus, the cylinder 12 is welded in place where its flat edge meets the flat bottom surface of the slave cylinder 16. This connection should be completely sealed by the welding process and free from fluid leaks. The bottom edge of this narrow cylinder 12 would be cut at a 45 degree angle which would allow another aluminum cylinder 12 with a 45 degree edge to meet with the vertical cylinder 12 horizontally. This connection would be welded together with a liquid tight seal. The other end of this horizontal cylinder 12 would have a symmetrical 45 degree edge, which would allow a vertical aluminum cylinder 12 with a 45 degree edge to meet with the 45 degree edge of the horizontal cylinder 12. Furthermore, this connection would be free of fluid leaks and sealed by the welding process. The finished welded assembly of the three cylinders is the slave hydraulic line 12. The upper end of this hydraulic line 12 is encompassed by a rubber hose 10 that is sealed mechanically with a fastener. This sealed would be free from liquid leaks. The rubber hose 10 is to extend from this connection to the master hydraulic line 8. The master hydraulic line 8 is constructed out of an aluminum cylinder that is approximately in the vertical positioned and parallel to its member master cylinder 4. A rectangular aluminum block (FIG. 5A) 74 has a bore through the length of its body and stops near the end surface. Two vertical holes are through the top surface of the rectangular block 74. These bores lead to the horizontal bore within the rectangular block 74. All three bores are ¼″ in diameter. One end of the longer bore is tapped and sealed with a fastener. Thus, the bore and fastened configuration allows hydraulic fluid to travel in a “U” shaped path. The vertical bore near the closed end of the rectangular block 74 is in alignment with the vertical bore next to the piston rod 6. This connection is sealed liquid tight by the welding process. The other bore is aligned to the vertical cylinder 8 that is parallel to the master cylinder 4. This alignment is sealed liquid tight by the welding process. The floor of the master cylinder (FIG. 5A) 4 is composed of two layers of aluminum plates that are welded to an aluminum ring next to the aluminum block 74. The bottom of the two plates has within its inner gap, which is between its inner circle and master piston 6 is a third rubber seal 1 that is design to prevent hydraulic fluid 9 from leaking between the chambers floor and master piston 6.

The piston rod 6 is made out of a steel cylinder which is welded to the master piston 5 member from its bottom surface. The piston 5 has a circular indication that is offset from the outer bottom surface. This allow the welding beads not to conflict when the bottom flat surface of the piston 5 meets the flat floor surface of the master cylinder 4. Both of these surfaces should meet in order to push the maximum amount of hydraulic fluid out into the slave cylinder 16 for the purpose of achieving maximum range in propulsion.

The bottom end of the piston rod 6 is welded to a circular piece of steel tubing 56 that would be formed into a “C” like shape with the tube of the lever machine 30 within its walls for being sustained above ground by a bolt 76 which occupies the bores of both components. The top surface of the tube holder 56 has a bore through its center and is encompassed by the end of the piston rod 6. A steel cable 14 runs through the bore in the tube holder 56 from inside the walls of the cylindrical piston rod 6, then loops around the tube of the lever machine 30 up into the cylindrical piston rod 6 and is bonded in place by a hardened resin of J.B. weld that was poured into the walls of the piston rod 6 and stopped at its base.

The loop of the steel cable 14 begins from the top and within the right side piston rod 6, then around the tube of its member lever machine 30, then up through the piston rod 6, then through the bore of the piston 5, then through the master cylinder 4, then through its right side symmetrical frame 2 member, then up and over the its mounted pulley wheel 78 member. Furthermore, the steel cable 14 continues to its left symmetrical mounted pulley wheel 78, then down through its left symmetrical frame 2 side, then through its left side hydraulic and lever machine components; the same steel cable would be bonded to the left force multiplying machines in the same way the reciprocal cable was assembled in the right hydraulic and lever machine components.

### OPERATION DESCRIPTION OF THE INVENTION

The hydraulic assisted propulsion mechanism would operate according to the drawings illustrated. When downward force is applied to the pedal 3 of the lever machine 30, the tube of the lever would pull down the piston rod 6 assembly coupled to the mid portion of the lever machine's tube with a pivotal connection at the tube holder 56. The piston rod assembly would include the tube holder 56, its fastener components, the steel piston rod 6, the steel cable bonded 14 within the piston rod 6 and the piston 5 with its rubber seal. The piston would push hydraulic fluid through the bore in floor of the master cylinder 4 through its hydraulic line 8. The hydraulic fluid would be transferred from the master hydraulic line 8 through the rubber hydraulic line 10. The hydraulic fluid would then flow through slave hydraulic line 12 connected to the rubber hydraulic line 10. The slave hydraulic line 12 would lead to the bottom center of the slave cylinder 16, which would allow hydraulic fluid to be pushed through the slave cylinder. This fluid would then push the slave piston 18 upwards with multiplying force because it would be pushing up against a larger surface area compared to the surface area of the master piston 5. Furthermore, because the master hydraulic assembly is being operated between the fulcrum and area of applied force on its member lever machine 30, this would produce more leverage than the force of a rider's weight bearing directly down on the tube holder 56.

The travel range of the hydraulic slave piston 18 would be about half the traveling range of the master piston 5. As a result, this would provide an above average amount of torque for a bicycle, but this amount of chain 20 movement alone would be insufficient for one downward pedal. So the hydraulic machine 66 would be more efficient being attached to a member lever machine 30 that would pivot and pull the transmission chain 20 at a distance equal to more than the distance traveled by the slave piston 18. The combination of both force multiplying machines would provide at least one revolution per pedal with an above average amount of torque. This combination of high torque to traveling range ratio should allow the rider to accelerate faster on the LEPS's hydraulic propulsion mechanism than other single speed bikes in its class.

### ADVANTAGES

Based on the inventions mechanical nature, the LEPS's Hydraulic Propulsion Mechanism has a number of advantages that is obvious due to these reasons:
(a) The hydraulic assistant mechanism should provide less effort to propel a rider from one point to another point while the person is pedaling the bike;
(b) The mechanism is easy to build compared to other hydraulic systems, which should reduce manufacturing cost;
(c) A hydraulic assisted mechanism would provide engineers with a greater range of pedaling performance configurations because fluid easily conforms to a great multitude of mechanical designs;
(d) Because the LEPS's hydraulic machine has a simple design, that means that the machine would also be durable because of its simplicity;

### CONCLUSION, RAMIFICATIONS AND SCOPE

Accordingly, the reader should visualize that the LEPS's hydraulic assisted propulsion mechanism is able to perform a variety of advanced pedaling functions that should benefit a bicyclist.

Firstly, the LEPS is able to accommodate the combinations of lever and hydraulic machines for the purpose of exploiting their force multiplying mechanical advantages in order to achieve maximum traveling speeds.

Secondly, the LEPS's hydraulic system is easy to construct provided that the master cylinder and slave cylinder components are composed of seamless modified tubes; furthermore, that the master and slave pistons are molded on a lathe machine.

Thirdly, various numerical specifications for speed, torque and traveling range could be easily manipulated simply by using these numbers to mathematically reverse hydraulic formulas to determine the inner volume of each master and slave cylinders as well as the surface area of their respective pistons.

Finally, a multi speed system could be easily constructed into the vertical plates to allow the load sprocket to move closer or away from its member fulcrum to increase pedaling range or reduce effort.

In conclusion, because the lever machine and hydraulic machine combination could be used with a multi speed system, as well as single speed models, the scope of the invention should be based on the independent claim that defines the essential elements of both force multiplying compound machines instead of the illustrations presented.

I claim:

1. A lever propelled bicycle having a master cylinder connected to its levers wherein the improvement comprises;
A first compound machine comprising a slave cylinder accommodating a piston, wherein the piston has the ability to pull its member transmission means while being moved pivotally by the member lever machine it is mounted to and a second duplicate compound machine, in which both alternately produces the effect of pulling its transmission means in one direction on a platform that is simultaneously moving, in a similar direction and thus the range and torque transferred though said transmission means is multiplied due to the combination of both force multiplying machines.

2. A lever propelled bicycle of claim 1 wherein there is a right master hydraulic machine connecting a right member lever machine to the right side of said bicycle's frame and a left member master hydraulic machine connecting a left member lever machine to the left side of said bicycle's frame;

3. A lever propelled bicycle of claim 1 wherein each said lever machine is “L” shaped with the shorter side in the approximate vertical position and the longer side in the approximate horizontal position while either one is pedaled to it lowest position.

4. A lever propelled bicycle of claim 1 wherein each master hydraulic machine has a master cylinder that is connected to its member side of the frame, furthermore a member piston rod is coupled to each member lever machine, while the opposite side of said rods has connected to it a piston with the ability to compress downwards hydraulic fluid inside its member master cylinder and transfer this hydraulic fluid to said slave cylinder member where the force of the hydraulic fluid is multiplied within its member slave cylinder having a piston with a greater surface area than its member master piston.

5. Lever machines in claim 3 wherein each lever machine pivots on a fulcrum that is located at the shorter end of each levers vertical portion.

6. The transmission means in claim 1 wherein the assembly reciprocates and is concealed inside the frame of said bicycle.

7. The master hydraulic machines in claim 4 wherein each piston rod has through it a steel cable loop within their cylindrical walls, wherein the opening of each loop is below the end of its member piston rod for maintaining a tight grip around its member lever machine tube for suspending the lever above ground, while between each loop is a continued single cable which is suspended by a right and left member pulley wheel mounted to the frame of said bicycle.
